(19) United States
(12) Patent Application Publication
(10) Pub. No.: US 2006/0097861 A1
(43) Pub. Date: May 11, 2006

(54) Signaling apparatus, in particular a signaling column

(76) Inventor: Juergen Marquardt, Rietheim-Weilheim (DE)

Correspondence Address: William D. Breneman, Esq.;BRENEMAN & GEORGES, 3150 Commonwealth Avenue, Alexandria, VA, 22305, US

(21) Appl. No.: 11/255,989

(22) Filed: Oct. 24, 2005

(30) Foreign Application Priority Data
Oct. 22, 2004 (DE) DE 10 2004 051 67
Mar. 24, 2005 (DE) DE 10 2005 014 34

(51) Int. Cl. G08B 29/00; G01C 25/00; B60Q 1/00; G08B 21/00

(52) U.S. Cl. 340/507; 340/679; 340/438; 340/635; 702/116

(57) ABSTRACT

A signaling apparatus is proposed, in particular a signaling column, for signaling of at least one operating state of a technical appliance such as a machine, an installation, a vehicle or the like, having at least one signaling element (5), in particular a light-emitting diode and/or a buzzer or the like, which considerably extends the application options. According to the invention, this is achieved in that the signaling apparatus has a monitoring unit (4), which is independent of the technical appliance, for monitoring the operating state of at least the signaling element (5), which monitoring unit (4) has at least one parameter input (8) for recording of a state parameter of the technical appliance.

The invention relates to a signaling apparatus, in particular a signaling column, according to the precharacterizing clause of claim 1.

### PRIOR ART

Signaling apparatuses, in particular signaling columns and/or buzzers or the like, are widely used for signaling or indication of operating states of technical appliances, such as machines, installations or vehicles. They are used primarily to signal, in particular visually and/or audibly, disturbances in the operation of such machines or installations, so that the operator is able to identify and to overcome these disturbances. Furthermore, signaling appliances such as these can also signal operating states which result in hazards for the surrounding area, or for people in the surrounding area.

In order to utilize the capability of machines or installations as well as possible, they are frequently operated continuously. In many manufacturing concerns, such machines run essentially fully automatically, so that only a very small number of operators and monitoring personnel are provided. In this case, it is impossible to avoid the fact that individual machines or installations cannot be monitored at some times, so that it is possible for unidentified disturbances in operation to occur, with the negative accompanied phenomena associated with them, such as a shut down, or even dangerous situations.

Appropriate signaling apparatuses, such as signaling columns, are already commercially available in widely differing variants. Signaling columns having a plurality of individual modules which can be plugged together are frequently used, in which case, for example, a base module, one or more signaling or light-emitting modules and/or an acoustic signaling module with a piezo buzzer or the like are provided. Furthermore, it is already commercial practice for light-emitting modules to have an incandescent lamp, one or more light-emitting diodes and/or flashlights as the light-emitting element.

In previous signaling apparatuses such as signaling columns etc., these apparatuses receive the instructions or commands from the technical appliance that, for example, a green light and/or red light and/or a buzzer etc. emits a signal for the respectively associated operating state of the technical appliance. This means that a monitoring unit for the technical appliance carries out the monitoring of the signaling apparatus or signaling column. The signaling apparatus just receives instructions or commands which it carries out as appropriate.

### OBJECT AND ADVANTAGES OF THE INVENTION

In contrast, one object of the invention is to propose a signaling apparatus, in particular a signaling column or the like, for signaling or indication of at least one operating state of a technical appliance, having at least one signaling element, in particular a light-emitting element such as a light-emitting diode and/or an acoustic signal transmitter such as a buzzer etc., which considerably extends the application options. Against the background of a signaling apparatus of the type mentioned in the introduction, this object is achieved by the characterizing features of claim 1. Advantageous embodiments and developments in the invention are possible by means of the measures stated in the dependent claims.

Accordingly, a signaling apparatus according to the invention is distinguished in that the signaling apparatus has a monitoring unit, which is independent of the technical appliance, for monitoring the operating state of at least one signaling element, which monitoring unit has at least one parameter input for recording of a state parameter of the technical appliance. This makes it possible for the signaling apparatus according to the invention to have “technical intelligence” for the processing of the state parameter, which intelligence is independent of the technical appliance to be monitored. This ensures a major extension to the application options in practice. For example, even technical appliances without any electronic monitoring unit, for example from previous decades, can be retrofitted or equipped according to the invention with a signaling apparatus or signaling column, including appropriate functionalities.

A corresponding situation also applies to technical appliances for which it was originally assumed that there was no need for signaling of an operating state and which thus have no appropriate precautions although, for example, appropriate signaling is desired or necessary as a result of widely differing changes to the constraints. According to the invention, even technical appliances such as these can be upgraded or extended in an advantageous manner so that a signaling apparatus according to the invention can provide signaling of the operating state of technical appliances such as these as well.

In principle, widely differing state parameters of the technical appliance can be supplied to the monitoring unit according to the invention, which can process in an advantageous manner in order to indicate the operating state of the technical appliance.

The state parameter is preferably in the form of a sensor parameter of a sensor. This measure allows the operating state to be recorded by the sensor and to be transmitted to the monitoring unit according to the invention, or to be made available to it. In contrast, it is also feasible for parameters which have already been at least partially preprocessed or sensor parameters to be made available to the monitoring unit according to the invention, or to be transmitted to it.

In one particular development of the invention, the sensor is in the form of a sensor for the technical appliance. This makes it possible to use an already existing sensor for the technical appliance in a particularly elegant manner for signaling of the operating state, thus making it possible to reduce the design complexity for implementation of the invention.

In one advantageous variant of the invention, the sensor is in the form of a sensor which is independent of the technical appliance. This makes it possible, for example, for technical appliances which until now have not had their own sensor system to be configured in such a way that it is possible to indicate an operating state. This once again considerably extends the application range of signaling apparatuses according to the invention, in comparison to the prior art.

Furthermore, technical appliances may also be designed to indicate an operating state, in which appliances, by way of example, a sensor or the like has been forgotten, or was originally not required for certain state parameters.

By way of example, specific sensors and/or sensors other than the sensors which are required for or exist in normal operation are required for setting up or for conversion of the technical appliance, for example for production of a different product or the like. According to the invention, for example, an additional and/or a separate sensor and/or a sensor which is independent of the technical appliance can be used, according to the invention, in a conversion and/or setting-up phase.

In principle, the invention makes it possible to provide a local area network, or a “LAN”, which can operate very largely independently of the technical appliance and of its hardware and/or software. Furthermore, the components which are required to indicate the operating state, such as the hardware and software, can in this case be very largely optimally matched to one another, thus allowing particularly advantageous signaling of the operating state.

In one advantageous embodiment of the invention, at least one plug unit which has a data line is provided for connection of at least the signaling element to the monitoring element. This makes it possible to produce an advantageous, in particular detachable, connection between the monitoring unit and the signaling element. For example, it is possible to use a commercially available signaling element which can be connected to the separate monitoring unit via a standard plug connection. This makes it possible, for example, to produce the signaling apparatus or signaling column according to the invention in a particularly financially advantageous manner. For example, retrofitting of already commercially available signaling apparatuses with the monitoring unit or “technical intelligence” according to the invention can be provided.

Alternatively or in combination with the embodiment mentioned above, at least one transmission unit is provided, having a transmitter for wire-free data transmission to a receiver. This makes it possible to provide wire-free data transmission in an advantageous manner, for example with appropriate wire-free data transmission taking place between the monitoring unit and the signaling element. This is particularly advantageous especially in localities in which, for example, the signaling element must be installed a long way up on the technical appliance and the monitoring unit according to the invention and/or a sensor for recording of a state parameter of the technical appliance are intended to be located a long distance away, or in localities where access is difficult.

Furthermore, this variant of the invention makes it possible, for example, to access a mobile receiver which can be carried in particular by an operator or monitoring person who is a long distance away, possibly even outside the company site. No modifications whatsoever are required for this purpose to the technical appliance to be monitored.

In the variant of the invention in which the signaling apparatus or the signaling module has a receiver, it is possible, for example, to receive signals without the use of wires, and to make such signals available to the appliance, the machine or the installation, or to use them for monitoring, in particular control purposes, in an advantageous manner. No modifications whatsoever are required for this purpose to the technical appliance or machine to be monitored.

In one advantageous development of the invention, the transmitter and/or the receiver is in the form of a subscriber to a public communications network. This means that there is no need to set up a separate data transmission path.

In one particularly advantageous embodiment of the invention, the transmitter and/or the receiver the signaling appliance is in the form of a replaceable module. This makes it possible to always equip only a selection of machines or installations with a transmitter according to the invention, with considerably reduced investment costs.

In one particular embodiment of the invention, a landline network telephone, a mobile radio telephone, a radio and/or a network subscriber and/or Internet subscriber is provided as the receiver and/or transmitter. In principle, all such communication devices are suitable for implementation of the invention. If the receiver and/or transmitter is in the form of a radio or mobile telephone, the corresponding transmitter and/or receiver in the signaling apparatus can likewise be in the form of a radio, mobile telephone or radio modem. The communication between the transmitter and/or receiver in the signaling appliance and the receiver and/or transmitter with the addressee of the signal, for example an operator, in this case takes place directly via the appropriate wire-free transmission path.

The nature of the signals to be transmitted can in general be configured in widely differing ways, depending on the application. For example, it is just as possible to provide for the transmission of a speech message as for the transmission of written messages, for example so-called SMS etc. However, the transmission of simple, for example symbolized, warning or information signals is also feasible without any problems.

Furthermore, particularly in the case of digital signal transmission, it is feasible without any problems to signal different operating states of the technical appliance that is provided with the signaling apparatus according to the invention. This relates not only to disturbing states, but it is also possible to indicate messages about the nature of the handling and maintenance activities to be carried out, such as the need to replenish magazines, carry out maintenance work etc., or else to provide a clear notification, so that an appropriate person can be called in good time, and in particular even before a disturbance occurs.

The monitoring unit preferably has a power supply which is independent of the technical appliance. This makes it possible to allow the signaling apparatus to be operated autonomously. This thus relates not only to parameter preprocessing with the aid of the monitoring unit according to the invention, but also, according to this variant, to the power supply. This allows the signaling apparatus to be operated very largely independently of the technical appliance and of its hardware and software.

By way of example, the signaling apparatus has a commercially available mains plug and/or a transformer unit and/or AC/DC rectifier or the like, and/or batteries or rechargeable batteries.

The monitoring unit is advantageously integrated in a housing which is separate from the technical appliance. This makes it possible, for example, to fit and fix the monitoring unit according to the invention independently of the technical appliance, at any desired locations. By way of example, the monitoring unit or the housing is fixed to the technical appliance.

In one particular development of the invention, the monitoring unit is integrated in a housing which is separate from the signaling element. This makes it possible to install the monitoring unit independently of the signaling element. Furthermore, this advantageously makes it possible to use signaling elements, signaling columns or the like which are already commercially available and to configure them according to the invention, or appropriately retrofit them.

The signaling apparatus is preferably in the form of a signaling column having at least one replaceable module and one base element. Commercially available components can also be used according to this variant, thus allowing low-cost production.

In one particular variant of the invention, the monitoring unit is integrated in the base element. Base elements which are already commercially available in general offer sufficient space to accommodate, for example, an electronic monitoring unit according to the invention. This measure means that there is no need for a separate housing for the monitoring unit, and/or commercially available signaling columns can be designed in a particularly simple manner according to the invention without this being visible, for example, to lay persons, at least at first glance.

The monitoring unit is advantageously integrated in the replaceable module. This variant of the invention also offers the capability for particularly simple retrofitting or upgrading of signaling apparatuses or signaling columns, which are already commercially available, according to the invention. Replaceable modules are in fact designed such that they can be replaced easily and generally without any restrictions. For example, a housing which is already commercially available for replaceable modules can be used for accommodation and integration of the monitoring unit according to the invention.

The transmission unit is preferably integrated together with the transmitter and/or receiver in the monitoring unit housing. This makes it possible to provide wire-free data transmission to, for example, commercially available signaling elements such as light-emitting elements and/or acoustic signal transmitters, in an elegant manner.

The transmission unit is advantageously integrated together with the transmitter and/or receiver in a replaceable module and/or base element of the signaling apparatus. This allows particularly simple retrofitting of commercially available signaling apparatuses according to the invention.

### EXEMPLARY EMBODIMENT

One exemplary embodiment of the invention is illustrated in the drawing and will be explained in more detail in the following text with reference to the single figure.

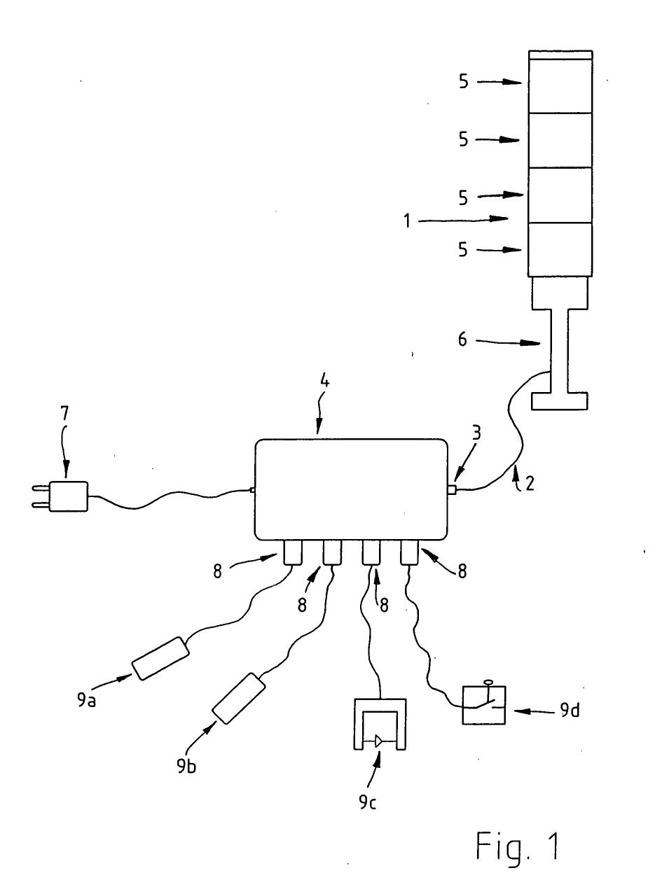

FIG. 1 shows, schematically, a design for a signaling apparatus according to the invention.

A light-emitting unit 1 or signaling column 1 is detachably connected in an advantageous manner in the illustrated exemplary embodiment via a line 2 and a plug 3 to a monitoring unit 4. The light-emitting unit 1 has a plurality of light-emitting modules 5 and/or replaceable modules 5 and a base element 6, via which the light-emitting unit 1 is connected to the monitoring unit 4.

A replaceable module 5 may, for example, also be in the form of a flash module, a glow light module, a light-emitting diode module, a piezo buzzer module or a horn module. Furthermore, a specific replaceable module 5 may also be in the form of a radio module for wire-free data transmission to a receiver/transmitter, which is not illustrated in any more detail. For example, the light-emitting unit 1 may admittedly be connected with the aid of the line 2 to the monitoring unit 4, but a corresponding radio module can be used, for example without the use of wires, to alarm an operator or monitoring person with a mobile telephone or the like.

The monitoring unit 4 has its own power supply 7 which, in the illustrated example, is in the form of a commercially available plug, in particular for 230 V AC. For example, an AC/DC rectifier or the like is provided in the monitoring unit 4, so that the light-emitting unit 1 can be supplied, for example, with 24 V DC.

The monitoring unit 4 or a housing of the monitoring unit 4 has, for example, four inputs 8 for state parameters for a technical appliance or the like which is not illustrated in any more detail. As shown in FIG. 1, the inputs 8 are in the form of sensor inputs for sensors 9. By way of example, four different sensor types are illustrated symbolically, with the sensor 9a being in the form of an inductive sensor, the sensor 9b a capacitive sensor, the sensor 9c an optical sensor or light barrier or the like, and the sensor 9d a mechanical sensor, probe or the like.

In principle, the illustrated variant of the invention can be designed such that the individual components can be connected or plugged together, for example, using the “plug and play” method and/or can be connected to the technical appliance. This means that the light-emitting unit 1 can be connected, for example, as a peripheral to the monitoring unit 4 without any need to install specific drivers or the like, or to make any other adjustments. A corresponding situation can also be achieved for a connection to a technical appliance, in a manner which is not illustrated in any more detail.

Furthermore, the sensors 9 can be connected to the monitoring unit 4 using the “plug and play” method, without any corresponding drivers or the like being required.

It is also feasible for at least one image recording unit to be provided for recording an image. The image recording unit is preferably in the form of a digital camera for recording digital images. It is likewise feasible to advantageously provide an audio recording unit for recording sounds and/or speech. With these variants of the invention, the area surrounding the signaling appliance can be monitored optically and/or acoustically, with advantageous signaling if required. This applies, for example, to theft protection and/or protection against accidents to the operators of corresponding machines. In this case, it is advantageous for the image recording unit and/or the audio recording unit to be connected to the technical appliance and/or to the monitoring unit according to the invention and/or using the “plug and play” method.

What is claimed is:

1. Signaling apparatus, in particular a signaling column, for signaling of at least one operating state of a technical appliance such as a machine, an installation, a vehicle or the like, having at least one signaling element (5), in particular a light-emitting element (5) and/or acoustic signal transmitter, characterized in that the signaling apparatus has a monitoring unit (4), which is independent of the technical appliance, for monitoring the operating state of at least the signaling element (5), which monitoring unit (4) has at least one parameter input (8) for recording of a state parameter of the technical appliance.

2. Signaling apparatus according to claim 1, characterized in that the state parameter is in the form of a sensor parameter of a sensor (9).

3. Signaling apparatus according to one of the abovementioned claims, characterized in that the sensor (9) is in the form of a sensor (9) for the technical appliance.

4. Signaling apparatus according to one of the abovementioned claims, characterized in that the sensor (9) is in the form of a sensor (9) which is independent of the technical appliance.

5. Signaling apparatus according to one of the abovementioned claims, characterized in that at least one plug unit (3) which has a data line (2) is provided for connection of at least the signaling element (5) to the monitoring unit (4).

6. Signaling apparatus according to one of the abovementioned claims, characterized in that at least one transmission unit is provided, having a transmitter for wire-free data transmission to a receiver.

7. Signaling apparatus according to one of the abovementioned claims, characterized in that the transmission unit is designed for data transmission between the monitoring unit (4) and the signaling element (5).

8. Signaling apparatus according to one of the abovementioned claims, characterized in that the monitoring unit (4) has a power supply (7) which is independent of the technical appliance.

9. Signaling apparatus according to one of the abovementioned claims, characterized in that the monitoring unit (4) is integrated in a housing which is separate from the technical appliance.

10. Signaling apparatus according to one of the abovementioned claims, characterized in that the monitoring unit (4) is integrated in a housing which is separate from the signaling element (5).

11. Signaling apparatus according to one of the abovementioned claims, characterized in that the signaling apparatus is in the form of a signaling column having at least one replaceable module (5) and one base element (6).

12. Signaling apparatus according to one of the abovementioned claims, characterized in that the monitoring unit (4) is integrated in the base element (6).

13. Signaling apparatus according to one of the abovementioned claims, characterized in that the monitoring unit (4) is integrated in the replaceable module (5).
